(19) United States
(12) Patent Application Publication
(10) Pub. No.: US 2024/0407327 A1
(43) Pub. Date: Dec. 12, 2024

(54) RESTRICTIVE DUAL ANIMAL FEEDING APPARATUS

(71) Applicant: Lily G. Clonan, Cazenovia, NY (US)

(72) Inventor: Lily G. Clonan, Cazenovia, NY (US)

(21) Appl. No.: 18/740,732

(22) Filed: Jun. 12, 2024

Related U.S. Application Data
(60) Provisional application No. 63/472,461, filed on Jun. 12, 2023.

(51) Int. Cl. A01K 5/01; A01K 7/00

(52) U.S. Cl. CPC A01K 5/0142; A01K 7/00

(57) ABSTRACT

A restrictive dual animal feeder includes an elevated feeder cabinet having at least one food and water container positioned on a top surface of the cabinet and configured and sized to feed large domestic animals. At least one other food and water container located elsewhere within the cabinet is configured and sized to feed smaller domestic animals, the at least one other food and water container having an access aperture located in the cabinet that can restrict access to the larger domestic animal.

### CROSS REFERENCE TO RELATED APPLICATION

This application claims priority to U.S. Patent Application Ser. No. 63/472,461, entitled: RESTRICTIVE DUAL ANIMAL FEEDING APPARATUS, filed Jun. 12, 2023, the pursuant to relevant portions of 35 U.S.C. § 119 and 35 U.S.C. § 120, the entire contents of which are herein incorporated by reference.

### TECHNICAL FIELD

The application relates to feeding devices for domestic animals, such as cats and dogs. More specifically and according to at least one aspect there is provided a single dual animal feeder that contains multiple compartments or stations for food and water for two or more animals of differing size or type. However, access to the food compartment of one of the animals is restricted to the other animal.

### BACKGROUND

The difficulties involved in feeding both a domestic cat and dog at the same time are well known among owners of both cats and dogs. The most common problem is that cats often feed sporadically during the day and therefore the cat's food is often available to a dog if unrestricted. Consequences of this problem can include unhealthy food portioning (the cat eating too little and the dog eating too much), cat and dog fighting over food, and the owner's mitigation methods such as guarding food, moving food bowls to separate closed rooms, and other labor intensive solutions. The present invention (henceforth referred to as “the feeder” or “the product” and which is not limited in scope to just cats and dogs) is unique in that it allows the owner to feed their cat and dog in the same exact place, as it separates the food between the two pets. The animal feeder also has a unique feature of simplicity, as it is aesthetically pleasing with any decor/environment, while serving its purpose.

Currently, there are no domestic-pet feeders in the market that function as both a cat and a dog feeder in one product. Dog feeders that feed dogs exist in the market and cat feeders that feed cats exist in the market. Variations of both dog and cat feeders also exist. Elevated dog feeders succeed in the pet market, but solely serve the purpose of feeding dogs at an elevated height for convenience, aesthetics, and pet health. Single bowl, dual bowl, restrictive bowls that allow slower feeding, and other goals exist. For cats, the biggest selling product is simply a bowl, which owners typically need to place in a separate room from their dog's area or on a raised counter out of reach of the dog, in order to restrict a dog's access to the cat's food. All of these products serve the purpose of feeding either a cat or a dog individually. However, an owner of both a cat and a dog may face problems when using these products in conjunction.

It has been observed that many families struggle with the family dog eating the food of the family cat. Many dog and cat owners have come up with solutions, but they are impractical and inconvenient to both the owners and the pets. Many owners explained they keep a small gate in front of the cat's food or keep the cat's food it in a separate room, or keep the cat's food on their kitchen counter. These proposed solutions are not fully effective.

### BRIEF DESCRIPTION

The present invention is directed to solving the above noted problems by providing an apparatus (a dual animal feeder) that compartmentalizes the smaller animal's (cat's) food and water in a way that is restrictive to the larger animal (dog), but remains accessible to the smaller animal (cat). This is accomplished by providing upper and lower food and water compartments and an access hole (aperture) in the food compartment of the smaller animal, which is located preferably below the elevated food compartment of the larger animal. Advantageously, the owner can easily assemble the apparatus on their own and fill the bowls in each compartment with food and water in a normal manner. Once assembled, the apparatus fits nicely with the aesthetics of just about any decor/room, and is light enough to be moved by the owner but built to be too heavy to be pushed around or otherwise affected by the pets.

An object of the herein described invention is to provide pet food and water to one and preferably two domestic animals of differing size and/or type.

A further object of the herein described invention is to provide individual bowls or containers within the feeder apparatus to hold food and water in separate and distinct compartments.

Yet another object of the herein described feeder apparatus is to provide pet food and water to both a domestic small animal and a domestic larger animal within the same apparatus. This is normally a cat and dog.

Still another object of the herein described apparatus is to restrict the access of the larger domestic animal to the food of the smaller domestic animal via an access aperture in the smaller animal's food (lower compartment) compartment.

Yet still another object of the herein described feeder apparatus is to make an access aperture of the smaller animal's food compartment (lower compartment) adjustable for different size animals in order, thereby making the apparatus tailorable for each animal.

Therefore and according to at least one version, there is described a restrictive dual animal feeder, comprising:
an elevated feeder cabinet with at least one food and water container positioned on a top surface to feed large domestic animals and at least one other food and water container located within the cabinet to feed smaller domestic animals with an access aperture located in the cabinet that can restrict access by the larger animal.

In at least one version, the cabinet can be molded as a single component. In at least one other version, the cabinet can be made from a plurality of multiple parts for easy assembly and disassembly, including the following parts configured to fit together:
an end panel with two negative slots on opposite ends of the end panel;
a side panel with two positive slots on opposite ends of the side panel;
two end and two side panels that when merged form a cabinet without a top or bottom: and
a top panel to cover the top portion of the cabinet and hold the food and water containers, wherein the positive connecting surfaces of the side panels may merge with the negative slots and the negative connecting surfaces of the end panels may merge with the positive slots.

Alternatively and according to another version, the access aperture in at least one of the panels can be adjusted to a desired dimension to adapt to the size of an animal to restrict access.

In at least one version, a cross bar spans an interior width of the cabinet, the cross bar being configured to stop containers from moving out of reach of animals.

Advantageously, the herein described dual feeder apparatus works with any two animals of differing size, but works particularly well because for the majority of domesticated cats and dogs owned, the dog is larger than the cat. The access aperture permits the smaller animal's compartment to be sized appropriately for the head of the smaller animal to enable the animal to access its food, but small enough to restrict access for the head of the larger animal.

Thus has been broadly outlined the general features of the herein described dual animal feeder apparatus so that the detailed description thereof that follows may be better described and that the present contribution to the art may be better appreciated.

These together with additional objects, features and advantages will be readily apparent to those of ordinary skill in the art upon reading the following Detailed Description of illustrative embodiments, when taken in conjunction with the following drawings.

In this respect, before explaining the current embodiments of the restrictive animal feeding apparatus in detail, it is to be understood that the herein described apparatus is not limited in its application to the details of construction and arrangements of the components set forth in the following description or illustration. Those skilled in the art will appreciate that the concept of this disclosure may be readily utilized as a basis for the design of other structures, methods, and systems for carrying out the several purposes of the restrictive animal feeding apparatus. It is therefore important that the invention be regarded as including such equivalent constructions insofar as they do not depart from the spirit and scope of the restrictive animal feeding apparatus. It is also to be understood that the phraseology and terminology employed herein are for purposes of description and should not be regarded as limiting.

### BRIEF DESCRIPTION OF THE DRAWINGS

FIG. 1 is a front perspective view of a one-piece molded animal feeder apparatus in accordance with aspects of the invention, including a sectional view of integrated top bowls and a removable bottom bowl;

FIG. 2 is a front perspective view of a disassembled multi-piece animal feeder apparatus in accordance with aspects of the invention;

FIG. 3 is a front perspective view of an assembled multi-piece feeder apparatus with removable top bowls;

FIG. 4 is a bottom perspective view of a feeder apparatus made in accordance with aspects of the invention, showing a sliding bar to adjust the aperture size of the opening of the lower compartment; and

FIG. 5 is a bottom perspective view of a feeder apparatus made in accordance with aspects of the invention, showing a cross bar to stop to keep the lower bowl stationary.

In all figures, the top panel includes provision for bowls or other receptacles that will contain food and water for the larger animal (such as a dog). Separate bowls are located in the lower compartment where a smaller animal (such as a cat) can access food contained in the bowl via apertures provided in the end panels of the feeder apparatus. For example, there is a sliding bar that can be used to adjust the size of the apertures that allows access for a smaller animal while at the same time restricting access for the larger animal. This allows feeding to be separate. By using the present invention, the owner saves time and energy from separating the two pets and their food in separate areas and the animals (cat and dog) are able to feed via the same apparatus and can have a healthy diet and relationship.

### DETAILED DESCRIPTION

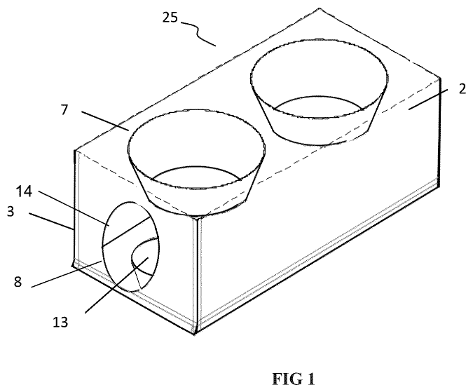

With reference now to the accompanying drawings, and in particular FIGS. 1 through 5 thereof, the principles and concepts of dual animal feeding apparatus generally designated by the reference number 25 will be described in accordance with a number of exemplary embodiments. For the sake of clarity, similar part numbers are labeled with the same reference numbers throughout.

Referring to FIGS. 1, 2, 3, 4, and 5, the dual animal feeding apparatus 25 commonly provides food and water feeding for large domestic animals (such as dogs) in top bowls 7 that are located in the top of the apparatus 25, also herein referred to as a top compartment of the apparatus. The feeding apparatus 25 also provides food and water feeding for one or more smaller domestic animals (such as cats) in a lower defined compartment 14. An access aperture 8 is located on one or both end panels 3 of the cabinet 2, thereby defining an apparatus frame that further defines an enclosure for the lower compartment with the exception of the access aperture 8. Access for the smaller animal to the lower compartment 14 is through the access aperture 8 that is of sufficient diameter or spacing for the head of the smaller animal to access the lower bowls 13 located in the lower compartment 14. The access aperture 8 has a diameter or spacing that is small enough to restrict the head and body of the larger animal from entering the lower compartment 14 and the food and water bowls 13 that are located within. In the herein described embodiment, the access aperture 8 is circular in configuration, but it can be readily assumed that other suitable shapes that are intended for the access aperture to allow access of the head of the smaller animal, while restricting access to the larger animal.

Referring to FIG. 1, the feeder apparatus 25 according to at least one exemplary embodiment is defined by a one-piece design with the top bowls/containers 7 being integrated into the apparatus 25. The one or two bottom bowls 13 are placed manually in the lower compartment 14. As such, the feeder apparatus 25 can be molded from a suitable plastic, although other materials such as wood or the like can be used.

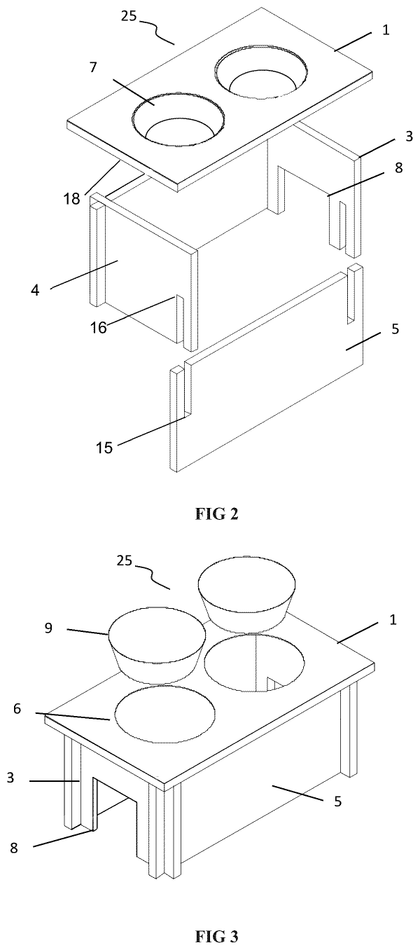

Alternatively, and referring to FIG. 2, the feeder apparatus 25 can be formed from a multi-piece configuration that consists of two side panels 5, an open end 3, and a closed end 4. A top panel 1 of the apparatus 25 includes integrated bowls 7 in spaced relation for food and water for the larger animal. The top panel 1 is attached to the top of the cabinet using fasteners or alternatively the ends of the panels 5, 3, and 4 can fit into a plurality of aligned grooves 18 formed in bottom of the top panel 1, as shown. The cabinet 2 is assembled by aligning the slot 15 with slot 16 on all corners and pushing the panels 5 into the end panels 3 and 4 until each of the edges are flush. The closed end 4 may or may not be in use, as the apparatus 25 may be used for multiple smaller animals (cats), in which case two open ends 3 could be provided.

Referring to an alternative embodiment or version shown in FIG. 3, the feeder apparatus 25 includes a top panel 1, the latter having respective holes 6 that are sized and configured to support removable bowls 9 for food and water for the larger animal.

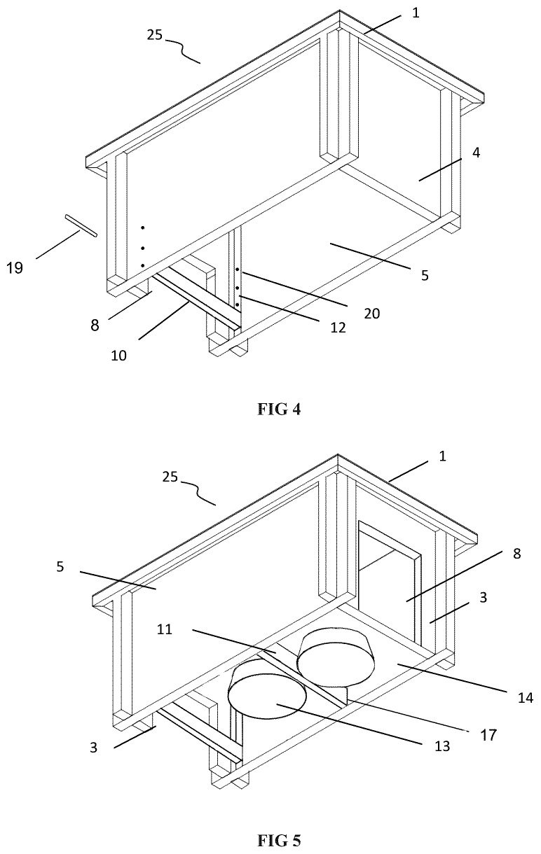

Referring to another alternative embodiment in FIG. 4, the feeder apparatus 25 has a bar 10 that fits into slots 12 formed on either side of the side panels 5. The bar 10 can move up or down in order to vary the size of the access aperture 8. The bar 10 is secured in the slots 12 using pins 19 through aligned holes 20. The size of the access aperture 8 can be selectively adjusted to accommodate a desired size by adjusting the pins 19 relative to the aligned holes 20.

Referring to yet another alternative version as shown in FIG. 5, the feeder apparatus optionally includes a bar 11 fits into a slot 17 in the side panels 5 that prevent a container (i.e., bowl 13) located in the bottom compartment 14 from being pushed far back into the feeder apparatus 25 and out of reach of the animal.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### PARTS LIST FOR FIGS. 1-5

1 top
2 cabinet
3 open end
4 closed end
5 side panels
6 holes
7 upper bowl, integrated
8 access aperture
9 upper bowl, integrated
10 slider bar
11 stop bar
12 slot for slider bar
13 lower bowl
14 lower compartment
15 slot on side panel
16 slot on end panel
17 slot for stop bar
18 top panel groove
19 pin
20 pin hole
25 apparatus

Therefore, the foregoing is considered as illustrative only of the principles of the present invention and it is understood that there are many variations and modifications apparent to those of skill in the art. Given the numerous modifications and changes will readily occur to those skilled in the art, it is not desired to limit the herein described apparatus to the exact construction and operation shown and described, and accordingly, all suitable modifications and equivalents may be restored to, falling within the intended scope of the present invention.

1. A restrictive dual animal feeder, comprising:
an elevated feeder cabinet having:
at least one food and water container positioned on a top surface of the cabinet and configured and sized to feed large domestic animals; and
at least one other food and water container located elsewhere within the cabinet that is configured and sized to feed smaller domestic animals, the at least one other food and water container having an access aperture located in the cabinet that can restrict access to the larger domestic animal.

2. The restrictive dual animal feeder according to claim 1, in which the cabinet comprises multiple parts for easy assembly and disassembly, including the following parts, which are configured to fit together:
an end panel having two negative slots on opposite ends of the end panel;
a side panel having two positive slots on opposite ends of the side panel,
two end panels and two side panels that when merged form the elevated feeder cabinet: and
a top panel sized and configured to cover the top portion of the cabinet and hold the food and water containers, wherein the positive connecting surfaces of the side panels merge with the negative slots, and the negative connecting surfaces of the end panels merge with the positive slots to form the elevated food cabinet.

3. The restrictive dual animal feeder according to claim 2, in which the access aperture is formed in at least one of the panels and in which the access aperture is selectively adjustable to a desired dimension in order to adapt to the size of an animal to restrict access thereto.

4. The restrictive dual animal feeder according to claim 1, further comprising a cross bar that spans an interior width of the cabinet, the cross bar being configured to stop the retained food containers from moving out of reach of animals.

5. The restrictive dual animal feeder according to claim 1, in which at least one the food and water containers are integrated into the feeder cabinet.

6. The restrictive dual animal feeder according to claim 1, in which at least one of the food and water containers are removably attachable to the feeder cabinet.

7. The restrictive dual animal feeder according to claim 1, wherein the feeder cabinet is molded as a single unitary component.
